(19) United States
(12) Patent Application Publication
(10) Pub. No.: US 2008/0305765 A1
(43) Pub. Date: Dec. 11, 2008

(54) Chat and Voice Service

(76) Inventor: Ian Eisenberg, San Jose, CA (US)

Correspondence Address: NEWMAN & NEWMAN, ATTORNEYS AT LAW, LLP, 505 FIFTH AVENUE SOUTH, SUITE 610, SEATTLE, WA, 98104, US

(21) Appl. No.: 11/758,552

(22) Filed: Jun. 5, 2007

(51) Int. Cl. H04M 11/00

(52) U.S. Cl. 455/406

(57) ABSTRACT

A chat service is free when used by an authenticated user of a mobile phone service. If a non-authenticated user attempts to use the chat service, the non-authenticated user may be allowed to access a subset of the chat system's user functions, the non-authenticated user may be allowed to access the chat service but only by also listening to advertisements, the non-authenticated user may not be allowed to access the chat service at all, and/or the non-authenticated user may be provided with an opportunity to become authenticated. Opportunities to become authenticated may include providing that the user may subscribe to a specific mobile phone service, may pay monetary consideration, and/or may provide other consideration, such as information about the user.

### BACKGROUND

Cellular or mobile telephone phone service has been commercially available since at least 1983 and is well known in the art. As used in this document, “mobile telephone service” is defined as follows: real-time communication of at least one audio signal between a user and potentially more than one other user through at least one base station, utilizing a wireless transmission medium and where the user utilizes communication equipment which includes a power source local to the communication equipment, such as a battery. The audio signal often, though not necessarily, comprises a human voice. The audio signal is often bidirectional, though need not be. Mobile telephone service may also include still and/or moving pictures and/or data files. Under this definition of “mobile telephone service” the communication equipment is not a general purpose personal computer, such as a laptop or desktop computer, though it may provide sufficient computing power to enable functions other than placing and receiving calls.

Mobile telephone service typically occurs between two or more users—a “conference call” being an example of mobile telephone service occurring between more than two users. The base station may be provided by any wireless communication technology, whether analogue, such as AMPS, or one of the many varieties of wireless digital cellular telephone communication technologies, such as, for example, D-AMPS, GSM, TDMA, CDMA, GPRS, EV-DO, EDGE, DECT, UMTS, and iDEN.

The sales and marketing of mobile telephone service has diversified over the years. Service plans generally combine some form of a subscription agreement, which provides that a subscriber may receive service from a particular provider for a period of time (such as a year), with one or more payment-specific rate plans which may apply during the service period, such as pay-as-you go (whether pre-paid or on a credit basis), flat-rate for a certain number of minutes of service used in a month (or over another period of time), as well as data-specific rate plans and rate plans which provide that unused service may be “rolled over” into subsequent service periods. Handsets and other user equipment (collectively referred to herein as a “communication equipment”) may be purchased by the user directly and/or communication equipment financing may be included in a service plan, either as a separate fee or as a cost born by the service provider and recovered over time.

There are also now a large number of parties providing phone and mobile phone service. This application defines “mobile virtual network operator” or “MVNO” as an entity which does not own or operate its own network of base stations nor licensed frequency spectrum, but which resells mobile phone service provided by another party which other party does own or operate base stations and licensed frequency spectrum.

Computer mediated chat services and technologies have developed alongside the development of the personal computer. Chat is defined in this document as a service wherein a user accesses a service which allows the user to leave messages for one or more than one other users (either individually, or together as a group) and to listen to messages left by other users. A typical chat service utilizes an interactive text (which may include SMS and related text technologies) and/or voice response system, hereinafter an “IVR” system, to provide access to and allow the creation of messages. The chat system may be programmed with multiple message boxes, each message box potentially containing one or more messages, and each message box being identified or identifiable, such as through textual and/or audio prompts or displays, with one or more topical categories, such as “women seeking men” and “Seattle area.” Message boxes and associated topical categories may be arranged in a hierarchical menu structure. The chat system may be provided with user functions, such as, for example and without limitation, to allow users to navigate the message box system, to record and re-record messages, to listen to messages, to delete messages, to set and change user profiles and user preferences.

While a diversity of mobile phone service plans exist, to date the art has not provided a chat service which is free when used by a user of a mobile phone service.

### SUMMARY

This summary is provided to introduce a selection of concepts in a simplified form that are further described below in the detailed description. This summary is not intended to identify key feature or essential features of the claimed subject matter, nor is it intended to be used to limit the scope of the claimed subject matter.

This document discloses methods and corresponding systems to provide a chat service which is free when used by an authenticated user of a mobile phone service. If a non-authenticated user attempts to use the chat service, the non-authenticated user may be allowed to access a subset of the chat system's user functions, the non-authenticated user may be allowed to access the chat service but only by also listening to advertisements, the non-authenticated user may not be allowed to access the chat service at all, and/or the non-authenticated user may be provided with an opportunity to become authenticated. Opportunities to become authenticated may include providing that the user may subscribe to a specific mobile phone service, may pay monetary consideration, and/or may provide other consideration, such as information about the user.

### DESCRIPTION OF THE DRAWINGS

FIG. 1 is an exemplary network and device diagram in and through which systems and methods consistent with the principals of the invention may be implemented.

FIG. 2 is an operational flow diagram generally illustrating steps consistent with certain aspects of the invention.

FIG. 3 is a functional block diagram of an exemplary computing device that may be used to implement one or more embodiments of the invention.

### DETAILED DESCRIPTION

The following detailed description refers to the accompanying drawings. The same reference numbers in different drawings identify the same or similar elements. The following detailed description is for the purpose of illustrating embodiments of the invention only, and other embodiments are possible without deviating from the spirit and scope of the invention, which is limited only by the appended claims.

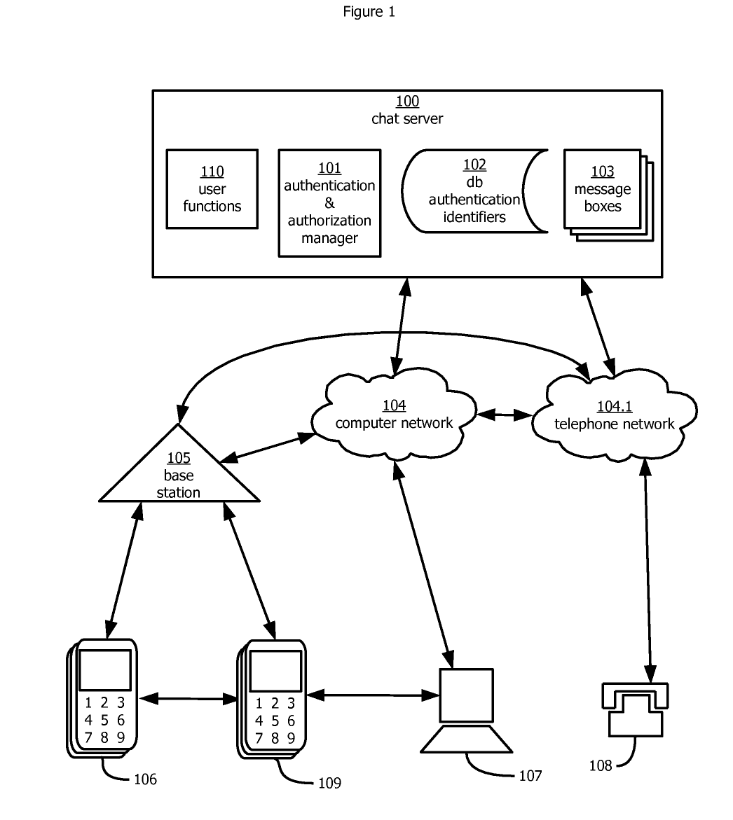

FIG. 1 generally depicts mobile phones 106 and 107. These communication devices are depicted engaging in direct communication with other devices, communicating through utilization of one or more base stations 105, and communicating through utilization of a network, such as a computer network 104 like the Internet and/or a telephone network 104.1. It should also be noted that communication devices may communicate directly with other communication devices through utilization of communication software and hardware such as, for example and without limitation, Bluetooth®, wireless mesh technology, and/or other ad hoc wireless and wired network technologies as are well understood in the art.

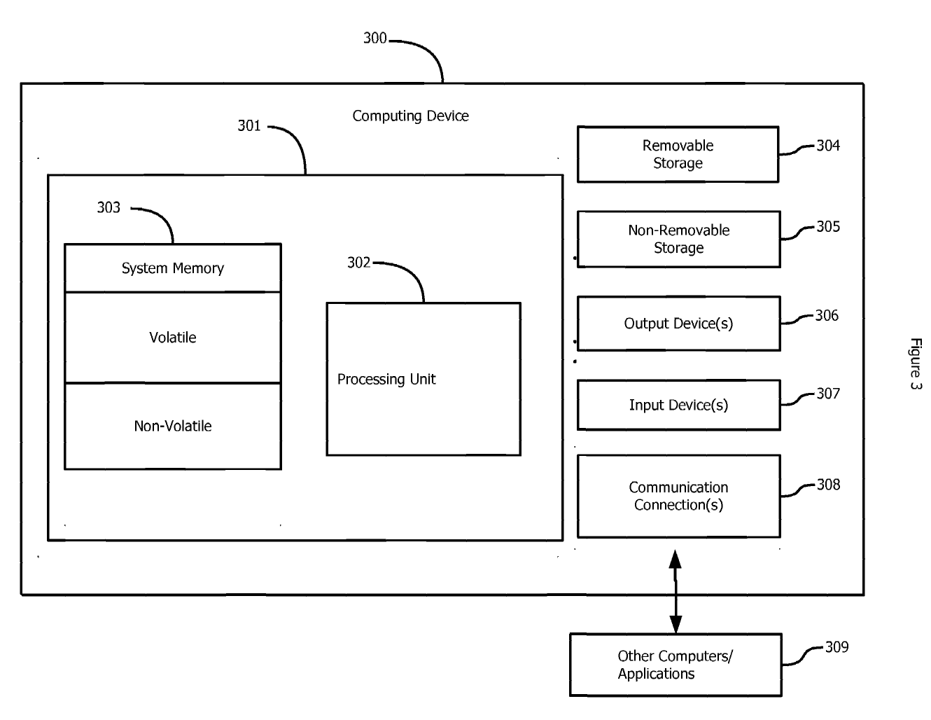

Also depicted in FIG. 1 is a chat server 100. The chat server 100 may be provided, for example and without limitation, by one ore more interactive text and/or voice response servers as are well known in the art. For example and without limitation, such servers are able to communicate with communication devices through telephone calls, through transmission of recorded audio/video files, through text messages, through email, and through text, graphica, and voice input and output provided by and to a user through a website or similar. For example and without limitation, such servers may be controlled through dual-tone multi-frequency signals (“DTMF” signals), speech recognition, text commands embedded in text messages, and/or through use of one or more application program interfaces (“APIs”). As an example and without limitation, such a server may be provided by one or more computing devices, such as the general purpose computing device depicted in FIG. 3. As is known in the art, such a server may be provided by multiple computing devices arranged in a grid, array, cluster, and/or distributed architecture, which multiple computing devices may act together to create one or more virtual instances of the server.

The chat server 100 is depicted as comprising user functions 110, an authentication and authorization manager 101, a database of authentication identifiers 102, and one or more message boxes 103. Any of these components may comprise and/or may be embodied in a database, webserver, IVR system application, or other application. These components are depicted as being within the chat server 100, though they may be provided by logically and/or physically distinct computers and/or applications which provide and/or embody equivalent functions. These components are also depicted as being separate from each other, though they may be provided by common software applications and/or hardware devices.

The user functions 110 comprise the set of commands through which users may direct the operation of the chat server 100. User functions 110 may comprise, for example and without limitation, commands to allow a user to receive descriptive information regarding the message boxes 103, to navigate a hierarchical or other arrangement of message boxes, to record or otherwise place messages in one or more message boxes, to listen to, view, or otherwise perceive pre-existing messages from or in message boxes, to request direct communication with another user, to access and/or change a user profile, and to request and control other services which the chat server 100 may provide.

The authentication and authorization manager 101 also depicted in FIG. 1 authenticates a potential user and authorizes the potential user relative to some or all of the chat server's user functions 110. Authentication is a process by which a user is authenticated (or not) as being a particular user or a member of a class or category of users. Authentication may be performed by obtaining authentication information from a user. Authentication information may comprise, for example and without limitation, one or more of a phone number, mobile identification number (or “MIN”), personal identification number (“PIN”), alpha-numeric character string, registration number, cookie, IP address, login identifier, password, biometric identifier, or similar. For example and without limitation, in an embodiment in which all and/or a portion of a telephone number is sufficient to authenticate a user, the authentication information may comprise all and/or a portion of the user's telephone number. For example and without limitation, authentication information may be obtained by the authentication and authorization manager 101 from a telephone 104.1 and/or computer network 104, it may be obtained from user input, and/or it may be obtained from a user's communication device. For example and without limitation, caller ID may identify the telephone number, MIN, or other identifying number relative to a calling party and/or a calling party's communication device, which number (or a portion thereof) may be used to authenticate the caller.

The database of authentication identifiers 102 serves as a repository for and provides authentication identifiers to the authentication and authorization manager 101. The database of authentication identifiers 102 may be provided by a database server operating database management system software. The information in the database of authentication identifiers 102 may be part of and/or may comprise a user profile. As used herein, a “user profile” is a set of information regarding a user. Such a set may comprise, for example, information such as a user's telephone number or other identification number associated with a user's communication device, a login identifier, password, biometric identifier or similar which a user may utilize to be authenticated and to be authorized with respect to the chat server 100, information regarding the services which are available and/or unavailable to the user, and information regarding the user's payment status relative to the service. Certain elements of a user profile may be modifiable by an authenticated and authorized user while certain elements may be modifiable by the system operator and/or by a third party.

Message boxes 103 are a component of the chat server 100. The chat server 100 may be programmed with multiple message boxes, each message box potentially containing one or more messages, and each message box being identified or identifiable, such as through textual and/or audio prompts or displays, with one or more topical categories, such as “women seeking men” and “Seattle area.” Message boxes and associated topical categories may be arranged in a hierarchical menu structure. Message boxes may also be assigned to specific users and/or categories of users. The user functions 110 may include commands which users may utilize to record messages for placement in all and/or specific message boxes. The user functions 110 may include commands which users may utilize to perceive messages from all and/or specific of the message boxes. Message boxes may be programmed to contain specific message formats, such as text or video, or may be programmed to contain a variety of message formats.

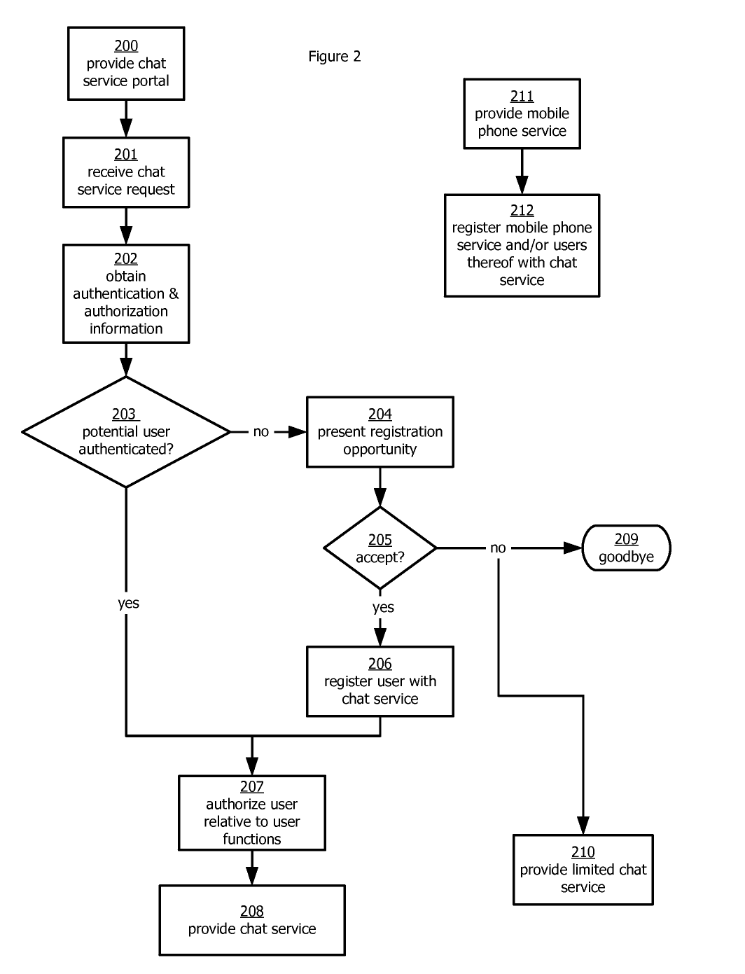

FIG. 2 depicts an operational flow diagram generally illustrating steps consistent with certain aspects of the invention. In an embodiment, a party provides mobile phone service 211. The provider of mobile phone service may be an MVNO. The same and/or different parties may provide the chat service and the mobile phone service. The mobile phone service may be offered and provided pursuant to any of the variety of service plans which presently exist or which may exist in the future.

Users of the mobile phone service may register or be registered with the chat service 212. Registration with the chat service 212 may comprise individual users providing user profile information to the authentication and authorization manager 101 and/or may comprise the provider of mobile phone service providing user profile information to the authentication and authorization manager 101. For example and without limitation, and much as noted above, user profile information may comprise all or part of a phone number (or similar). For example and without limitation, a provider of mobile phone service, who may be the same as the provider of chat services, may register some or all of the provider's mobile phone customers by providing all or part of the phone numbers of such customers to the authentication and authorization manager 101. In this document, such a mobile phone service is said to be a mobile phone service registered with the chat service or, more simply, a “registered mobile phone service.” In an embodiment, a part of a phone number, such as the first six digits, may be sufficient to authenticate a potential user as a user of a registered mobile phone service; in which case a registered mobile phone service may only need to provide the authentication and authorization manager with such part of a phone number. Potential users of the chat services may or may not be further required to register with and to provide additional user profile information to the authentication and authorization manager 101.

A party utilizes a chat server 100 to provide a chat service portal 200. A chat service request may then be received 201. The chat service request may comprise a voice telephone call, a received recorded voice (or other audio) file, a received text message, a received email, and/or text and/or voice input provided by a user through a website, a chat client software application, or similar. Authentication information, if any, which may comprise part of the chat service request, such as, for example and without limitation, a phone number associated with the chat service request, may be obtained 202. For example, the chat server 100 may be configured to obtain the caller ID information associated with a phone call and to use this information to authenticate the caller. Additional authentication and authorization information may be provided and/or obtained 202, as discussed above.

The authentication and authorization information is evaluated by comparison to the information in the database of authentication identifiers 102 and other of the user profile information. A decision may be made based on this comparison regarding whether the party making the chat service request is authenticated 203. If authenticated, then the user may be allowed to utilize the chat services without payment of additional consideration and/or without registration (as discussed further below). If not authenticated, an embodiment provides that the potential user may be presented with an opportunity to become authenticated 204, such as by registering with the chat service 206. Registration with the chat service may involve, for example and without limitation, responding to voice, text-, and/or graphically-based prompts and/or instructions to provide user profile information, to indicate acceptance of terms, and/or to approve billing for the chat services. Consideration, if any is required, for the chat services may be paid through any of a variety of means, such as by credit and/or debit card, check, cash, wire, direct deposit, by having the services billed to the user by the user's telephone service carrier, through utilization of a coupon or promotion code, or similar.

If the user does not accept the opportunity, if any, to become a registered user, then the chat server 100 may present the user with a parting salutation 209 and/or the user may be allowed to access the chat service, but with a reduced set of user functions (as discussed above) 210. For example, an unauthenticated user may be allowed to listen to (or otherwise perceive) information regarding the chat service, regarding mobile phone service, regarding the topics of message boxes and the arrangement of the message boxes, as well as a limited set of messages left by other users on the system.

If the user accepts the opportunity and registers with the chat service, or if the user was previously identified at step 203 as an authenticated user (in which case payment of consideration and/or further registration may not be necessary), the chat server 100 may proceed to an optional step 207 wherein authenticated users are authorized relative to specific of the user functions, if all user functions are not provided to all users. Following this step, the user may be provided with the chat services 208.

FIG. 3 is a functional block diagram of an exemplary computing device 300 that may be used to implement one or more embodiments of the invention. The computing device 300, in one basic configuration, includes at least a processor 302 and memory 303. Depending on the exact configuration and type of computing device, memory 303 may be volatile (such as RAM), non-volatile (such as ROM, flash memory, etc.) or some combination of the two.

Additionally, device 300 may also have other features and functionality. For example, device 300 may also include additional storage (removable and/or non-removable) including, but not limited to, magnetic or optical disks or tape. Such additional storage is illustrated in FIG. 3 by removable storage 304 and non-removable storage 305. Computer storage media includes volatile and nonvolatile, removable and non-removable media implemented in any method or technology for storage of information such as computer readable instructions, data structures, program modules or other data. Memory 303, removable storage 304 and non-removable storage 305 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 300. Any such computer storage media may be part of device 300.

Computing device 300 includes one or more communication connections 308 that allow computing device 300 to communicate with one or more computers and/or applications 309. Device 300 may also have input device(s) 307 such as a keyboard, mouse, digitizer or other touch-input device, voice input device, etc. Output device(s) 306 such as a monitor, speakers, printer, PDA, mobile phone, and other types of digital display devices may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. From the foregoing, it will be appreciated that specific embodiments of the invention have been described herein for purposes of illustration, but that various modifications may be made without deviating from the spirit and scope of the invention. Accordingly, the invention is not limited except as by the appended claims.

What is claimed is:

1. A method of providing mobile telephone and chat services, comprising the following steps:
providing mobile phone service to at least one user;
providing a chat service;
determining if a potential user of the chat service is a authenticated user of the mobile phone service;
allowing an authenticated user of the mobile phone service to use the chat service.

2. The method according to claim 1, where allowing an authenticated user of the mobile phone service to use the chat service further comprises not charging consideration for such use of the chat service.

3. The method according to claim 1, further comprising allowing a non-authenticated user to become authenticated and to use the chat service
by becoming an authenticated user of the mobile phone service, or
by payment of consideration.

4. The method according to claim 1, where providing mobile phone service to a user further comprises the steps of:
obtaining mobile phone service from a third party, which third party owns and/or operates a network of base stations and licensed frequency spectrum; and
reselling such obtained mobile phone service to the user.

5. The method according to claim 1, where providing a chat service comprises:
providing access to an interactive text and/or voice server, which server is configured with:
topically organized message boxes; and
user functions.

6. The method according to claim 5 where user functions comprise:
allowing users to leave messages in some and/or all message boxes; and
allowing users to perceive messages in some and/or all message boxes.

7. The method according to claim 5, further comprising allowing a non-authenticated user of the chat service to use a subset of user functions.

8. The method according to claim 1, where determining if a potential user of the chat service is an authenticated user of the mobile phone service further comprises:
determining a phone number associated with the potential user;
comparing the determined phone number to phone numbers in a database of phone numbers of authenticated users.

9. A system to provide chat services comprised of:
an interactive text and/or voice response system configured to provide chat services and configured with message boxes and user functions;
an authentication and authorization manager configured to determine whether at least one potential user of the chat services is an authenticated user of a registered mobile phone service.

10. The system according to claim 9 where the registered mobile phone service is operated by an MVNO.

11. The system according to claim 9 where the user functions comprise:
the ability to leave messages in some or all message boxes; and
the ability to perceive messages in some or all message boxes.

12. The system according to claim 9 where the authentication and authorization manager is further configured to allow access to all, a subset of, or none of the user functions depending on the outcome of the determination.

13. The system according to claim 9 where the authentication and authorization manager determines whether the at least one potential user of the chat services is an authenticated user of the mobile phone service by steps comprising:
determining a phone number associated with the potential user;
comparing the determined phone number to phone numbers in a database of phone numbers of authenticated users.

14. The system according to claim 9 where a registered mobile phone service is one which has provided authentication information to the authentication and authorization manager.

15. The system according to claim 14 where authentication information comprises some or all of one or more phone numbers.

16. A method of providing chat services, comprising the following steps:
providing an an interactive text and/or voice server, which server is configured with message boxes and user functions;
registering at least one telephone service provider;
determining if a party attempting to access the interactive text and/or voice server is an authenticated user of a registered telephone service.

17. The method according to claim 16 further where user functions comprise allowing users to leave messages in message boxes and allowing users to listen to messages in message boxes.

18. The method according to claim 16 further comprising allowing authenticated users to access all user functions.

19. The method according to claim 16 further comprising allowing non-authenticated users to access a subset of or none of the user functions.

20. The method according to claim 16 further comprising allowing non-authenticated users to become authenticated through payment of consideration.

21. The method according to claim 16 where determining if a party is an authenticated user further comprises:
determining a phone number associated with the user;
comparing the determined phone number to phone numbers in a database of phone numbers of authenticated users.

22. The method according to claim 16 where registering at least one telephone service provider further comprises obtaining authentication information from the at least one telephone service provider.

23. The method according to claim 22 where authentication information comprises some or all of one or more phone numbers.
